(19) United States
(12) Patent Application Publication
(10) Pub. No.: US 2006/0044176 A1
(43) Pub. Date: Mar. 2, 2006

(54) ELF/VLF wave generator using a virtual vertical electric dipole

(75) Inventor: Dennis Papadopoulos, Chevy Chase, MD (US)

Correspondence Address: ROSSI, KIMMS & McDOWELL LLP., P.O. BOX 826, ASHBURN, VA, 20146-0826, US

(73) Assignee: BAE Systems Advanced Technologies, Inc.

(21) Appl. No.: 10/928,692

(22) Filed: Aug. 27, 2004

(51) Int. Cl. G01S 13/08

(52) U.S. Cl. 342/1

(57) ABSTRACT

A high efficiency system generates a VED virtual antenna by taking advantage of the vertical electric field created by natural effects in the lower ionosphere at latitudes in the vicinity of the dip equator. An ionospheric heater is employed to direct a heating radiation beam into a region of the ionosphere located at an altitude of 75-105 Km. The heating effect of the beam drives vertical oscillator currents that radiate ELF/VLF signals in the ionosphere.

### BACKGROUND

The invention relates to the generation of Very Low Frequency (VLF) and Extremely Low Frequency (ELF) Vertical Electric Dipole (VED) moments that can couple into a waveguide formed by the conducting earth and ionosphere.

VLF and ELF waves suffer low absorption and can therefore penetrate into seawater and the ground. Accordingly, VLF and ELF waves are used extensively to communicate with submerged submarines, signal underground or underwater installations and objects, and perform underground imaging. Since ELF/VLF waves have wavelengths from tens to thousands of kilometers, radiating antennas are electrically short. As a result, practical radiating antennae in conventional systems designed to generate ELF/VLF waves are Horizontal Electric Dipoles (HED), as they can be made much longer than vertical dipoles. HED antennae, however, are extremely inefficient and must be located above poorly conducting ground so that the return current path through the ground generates a large loop. The U.S. Navy's fixed-ELF system located in Michigan, for example, generates signals at 76 Hz for submarine communications, has a 45 km horizontal length and an HED moment of approximately 7×10³ A-km, and radiates only a few Watts in the far field that couples into the waveguide formed by the earth and the ionosphere. The radiating power is of the order of 10⁻⁶ or less of the power that drives the antenna.

A major factor for the low coupling efficiency of the above-described system is the mismatch between the electric field generated by the antenna, which is predominantly horizontal, and the normal Transverse Electric Mode (TEM) of the wave-guide which is predominately vertical and can be best excited by a VED. Current techniques for generating VLF and ELF waves, however, rely on Horizontal Magnetic Dipoles (HMD) whose efficiency is lower by more than 40 dB than equivalent VEDs.

An understanding of the low coupling efficiency can be illustrated by a simplified analysis taking into consideration a simple model of the earth and the ionosphere represented by perfectly conducting planes. In a cylindrical coordinate system (ρ, φ, z) where the ground is taken at z=0 and the ionosphere at z=h, assume that the source is a VED with a dipole moment located on the ground. The electric field at any point inside the waveguide is also vertical and can be computed by considering the images of the VED. Since infinite conductivity is assumed, the images are located at z=(+/−) 2 h, 4 h . . . etc. These images will direct the wave broadside since they radiate in phase. At distances large related to h the field can be computed by replacing the line of images with an infinite continuous line source carrying an equivalent current Iₑ given by:
Iₑ=Il/h Eq. (1)
The field from such a line source is well known and is given by:

$${E}_{2} = \frac{μω {I}_{e}}{4} {H}_{o}^{( 2 )} ( k ρ ) \qquad Eq . ( 2 )$$

where H₀⁽²⁾ is the Hankel function of the second kind. For the far field (p>>λ) the asymptotic form of the Hankel function for kp>>1 to find:

$${E}_{{2}_{2}}^{VED} ≅ {Z}_{o} \frac{H}{2 h \sqrt{πρ}} exp ( ⅈπ / 4 ) exp ( - ⅈk ρ ) \qquad Eq . ( 3 )$$

where Z₀=120π is the free spaced inductance. Use of finite ground conductivity does not affect the result for the vertical field. It simply introduces a small component of the radial field E_{ρ} that is by (εω/σ)^{1/2}, smaller than the vertical field, where ε and σ are the dielectric constant and the ground conductivity.

Now consider an HED with moment 11 over a ground with conductivity σ. The current will close through the ground at a distance approximately equal to the skin depth δ=(2/ωμσ)^{1/2} As a result, the HED is equivalent to a Horizontal Magnetic Dipole (HMD) with the magnetic moment given M by:
M=Ilδ Eq. (4)
The electric field E_{z} eradiated by this source can be found by using a similar image method as before. If both the perimeter of the loop and h are much smaller than the wavelength λ, neither its position nor its shape affect the far field. One may then distort and reposition the original loop into a form that simplifies the derivation. Namely, taking the loop height as h, filling the height of the waveguide and its width as 1δ/h so that M is invariant. Assuming large conductivities for the earth and the ionosphere and applying the image method, one sees the images of the horizontal currents cancel the adjacent current, while the vertical currents and their images are in the same direction. Therefore, the total field will be due to a pair of anti-parallel currents each carrying a current I and separated by a distance d=1δ/h.

Using the same procedure as above and taking the array factor for the two wires with the distance d as −kdcos φ one finds:
E_{z}^{HED}=(kδ cos φ)E_{z}^{VED} Eq. (5)
which can be written as:

$$\frac{{E}_{z}^{HED}}{{E}_{z}^{VED}} ≅ 1 / η \\ η = \sqrt{σ / ɛω} \qquad Eq . ( 6 )$$

In practical units, the value of η can be written as:

$$η \approx 100 \sqrt{\frac{σ}{{10}^{- 4}}} \sqrt{\frac{200 Hz}{f}} \qquad Eq . ( 7 )$$

Namely, depending on the frequency and ground conductivity, the HEDs radiate by 40 dB or more less efficiently than an equivalent VED.

Since generating VEDs in the ELF/VLF frequency range using conventional technology is severely limited by the structural length of the antenna (on the order of several kilometers) and the Corona discharge limitations at high voltages, it would be desirable to provide an apparatus and method of generating large VED moments that radiate at ELF/VLF frequencies and inject their power in the earth-ionosphere waveguide without the use of conventional antenna structures.

### SUMMARY OF THE INVENTION

The invention provides an apparatus and method for generating large VED moments that radiate at ELF/VLF frequencies and inject their power into the earth-ionosphere waveguide. In operation, VED “virtual” antenna is generated by taking advantage of the vertical electric field created by natural effects in the lower regions of the ionosphere at latitudes in the vicinity of the dip equator.

Specifically, an ionospheric heater is positioned to propagate power from a heating radiation beam into a location of the ionosphere above the dip equator. A controller controls the operation of the ionospheric heater to cause the heating radiation beam to generate vertical oscillatory currents in the ionosphere that radiate ELF/VLF signals. The location of the ionosphere into which the power from the heating radiation beam is propagated is preferably between about 75-105 km. The operation of the ionospheric heater can further be controlled to sweep the heating radiation beam at a horizontal speed faster than the phase velocity of a whistler wave supported by the ionosphere. The operating frequency of the ionospheric heater is preferably adjusted to deposit an optimized amount of power from the heating radiation beam at the desired location. The preferred frequency operating ranges is between about 2-15 Mhz.

### BRIEF DESCRIPTION OF THE DRAWING

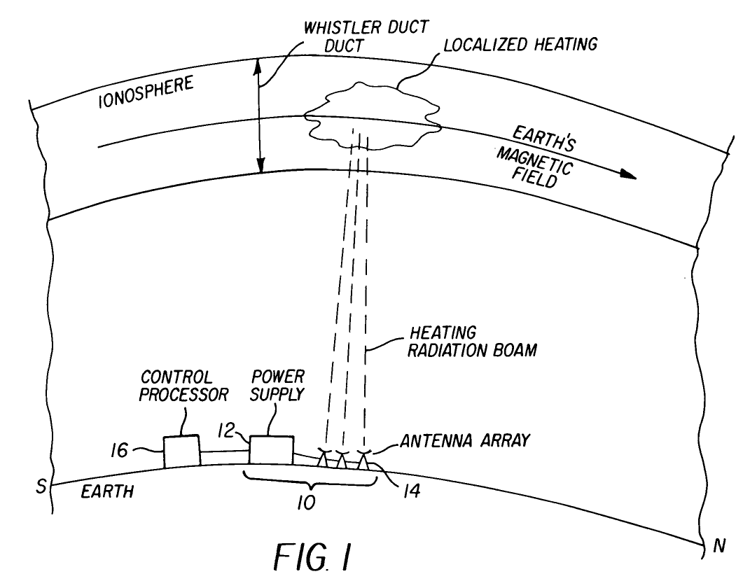

The invention will be described with reference to the preferred embodiments of the invention and the accompanying FIG. 1 which schematically illustrates a system for generating a virtual antenna in the ionosphere above the dip equator.

### DETAILED DESCRIPTION OF THE PREFERRED EMBODIMENTS

Technologies have recently been introduced that can generate large values of HEDs or equivalent HMDs in the ELF/VLF frequency range. The technique relies on the modulation of natural currents that flow in the lower (70-100 km) high altitude ionosphere known as the auroral electrojet. These currents are driven by the interaction of the conducting solar wind intercepting the earth's magnetic field acting as a dynamo. The currents flow vertically along the highly conducting magnetic field lines and close at altitudes between 70-110 km, where collisions allow them to flow across magnetic field line forming the auroral electroj et current. The current is a horizontal current and, while it can reach values in excess of 0.5 MA, the current density is very low, on the order of few times 10⁻⁷ A/m².

Modulation of the current is accomplished by using a high power ground transmitter with frequency from 2-15 MHz. When the transmitter is ON the HF energy is absorbed by the ionosphere in the electrojet region heating the electrons. Electron heating results in modification of the local conductance and altering the path of the current flow. When the transmitter is OFF, the current returns to its original path. If the heating process is carried out in an intermittent manner with the HF pulsing frequency in the ELF/VLF range, the oscillating current acts as an HED or an equivalent HMD radiating at the driving frequency in a manner similar to a ground based dipole. This “virtual” antenna is created at the top rather than the bottom of the waveguide but has similar radiating properties. This concept provides at least an order of magnitude better bandwidth than the conventional techniques and avoids the engineering and environmental problems associated with tens of km antenna lengths. Since the resultant virtual antenna is of the HED type, however, it suffers from the same 40 dB or more inefficiency associated with the conventional antennas.

The virtual antenna described above is of an HED type due the magnetic geometry at high latitudes, namely, the geomagnetic field is vertical in the auroral region. Since the magnetic field lines are close to equipotentials, physics does not permit the presence of any significant vertical electric fields. Any vertical electric field quickly becomes shorted out by the large values of the conductivity of the magnetic field. The only electric fields allowed are perpendicular to the magnetic field lines.

The present invention is based in part on a recognition that the magnetic geometry at high altitudes can be used to an advantage, namely, a VED virtual antenna can be achieved by taking advantage of the vertical electric field created by natural effects in the lower ionosphere at latitudes in the vicinity of the “dip equator”. The dip equator is a region where the geomagnetic field is completely horizontal, i.e., perpendicular to the direction of the earth's radius. Accordingly, a high power transmitter (known as an ionospheric heater) operating at a frequency of 2-15 MHz and transmitting a beam directed to a location in the ionosphere at latitudes in the vicinity of the dip equator will generate a VED virtual antenna.

As illustrated in FIG. 1, for example, an ionospheric heater 10 is located at a position along the dip equator. The ionospheric heater 10 includes a power source 12 and an antenna array 14. A control processor is used to control the overall operation of the ionospheric heater 10. The ionospheric heater 10 may be located on land, on a sea based platform or potentially even on a spaced based platform. The ionospheric heater 10 generates a heating radiation beam that is directed to the ionosphere, preferably at altitudes ranging from 75 km to 105 km depending on the plasma density profile. The ionospheric heater 10 preferably operates in a frequency range of 2-15 MHz. It will be understood that the frequency may be adjusted by the control processor 16 to prevailing ionospheric conditions, so that the power of the heating radiation beam is deposited at an optimal location with respect to the vertical electric field. The control circuitry 16 can also be employed to direct the heating radiation beam to temporally modulate in the region of the ionosphere that supports the vertical electric field above the dip equator to cause periodic heating of the ionospheric electrons. Still further, the control processor 16 can be utilized to control the operation of the antenna array 14 to sweep the heater beam horizontal with a speed that matches the local phase velocity of the whistler mode propagating along the magnetic field in the above-described altitude range.

The apparatus described above generates a VED virtual antenna that generates vertical oscillatory currents whose far field radiation can couple by several tens of dB more efficiently than previous conventional methods. The vertical currents radiat omindirecationally. Accordingly, the VED virtual antenna provides the advantages desired of using the vertical field without the disadvantages associated with conventional antenna structures.

The invention has been described with reference to certain preferred embodiments thereof. It will be understood, however, that modifications and variations are possible with the scope of the appended claims. For example, it will be understood that the horizontal parts of the oscillatory currents excited by the heater will excite the whistler duct located in the inonosphere at altitudes between 90-120 kilometers. Accordingly, long propagation paths along the North-South and South-North directions can be achieved.

What is claimed is:

1. An apparatus comprising:
an ionospheric heater positioned to propagate power from a heating radiation beam into a location of the ionosphere above the dip equator; and
a controller that controls the operation of the ionospheric heater to cause the heating radiation beam to generate vertical oscillatory currents in the ionosphere that radiate ELF/VLF signals.

2. An apparatus as claimed in claim 1, wherein the location of the ionosphere into which power from the heating radiation beam is propagated is between 75-105 km.

3. An apparatus as claimed in claim 1, wherein the controller controls the operation of the ionospheric heater to sweep the heating radiation beam at a horizontal speed faster than the phase velocity of a whistler wave supported by the ionosphere.

4. An apparatus as claimed in claim 1, wherein the controller adjusts an operating frequency of the ionospheric heater to deposit an optimized amount of power from the heating radiation beam at the location.

5. An apparatus as claimed in claim 1, wherein the ionospheric heater operates at a frequency between 2-15 Mhz.

6. A method of generating ELF/VLF signals in the ionosphere comprising:
generating a heating radiation beam; and
transmitting the heating radiation beam to a location in the ionosphere located above the dip equator;
wherein the heating radiation beam drives vertical oscillator currents that radiate ELF/VLF signals in the ionosphere.

7. A method of generating ELF/VLF signals as claimed in claim 6, wherein the heating radiation beam operates in a frequency range of from 2-15 Mhz.

8. A method of generating ELF/VLF signals as claimed in claim 6, wherein the location in the ionosphere is located from an altitude of 75-105 Km.

9. A method of generating ELF/VLF signals as claimed in claim 6, further comprising sweeping the heating radiation beam at a horizontal frequency faster than the phase velocity of the whistler wave supported by the ionosphere.

10. A method of generating ELF/VLF signals as claimed in claim 6, further comprising adjusting a transmission frequency of the heating radiation beam to optimize the amount of power deposited at the location.

11. A method of generating ELF/VLF signals as claimed in claim 6, wherein the horizontal part of the oscillating currents excited by the heater excite the whistler duct located in the ionosphere at alitudes between 90-120 km.
